(19) United States
(12) Patent Application Publication
(10) Pub. No.: US 2022/0173797 A1
(43) Pub. Date: Jun. 2, 2022

(54) SATELLITE DYNAMIC CONSTRAINTS

(71) Applicant: HUAWEI TECHNOLOGIES CO., LTD., Shenzhen (CN)

(72) Inventors: Peter ASHWOOD-SMITH, Gatineau (CA); Mehdi Arashmid AKHAVAIN MOHAMMADI, Ottawa (CA)

(73) Assignee: HUAWEI TECHNOLOGIES CO., LTD., SHENZHEN (CN)

(21) Appl. No.: 17/108,226

(22) Filed: Dec. 1, 2020

(51) Int. Cl. H04B 7/185

(52) U.S. Cl. CPC H04B 7/18513; H04B 7/18519

(57) ABSTRACT

A method is provided for setting an attribute of a link between an aerial network node and another node. The method comprises determining that a geographic condition of the link in relation to the aerial network node is satisfied. The method further comprises setting at least one attribute of the link to match at least one attribute associated with the geographic condition. Further, an aerial network node is provided including a network interface, a processor, and a non-transient computer readable memory for storing instructions which when executed by the processor configure the aerial network node to determine that a geographic condition of a link between the aerial network node and another node, in relation to the aerial network node is satisfied. The network node is further configured to set at least one attribute of the link to match at least one attribute associated with the geographic condition.

### FIELD OF THE INVENTION

The present invention pertains to the field of wireless communications networks, and in particular to methods and devices for techniques of traffic engineering while components of the network itself are moving.

### BACKGROUND

A satellite network (or constellation) in non-geosynchronous orbits, which includes inter-satellite links (ISLs), will see the links status and characteristics between satellites change as the satellites move around the Earth. It is noted that satellites change directions (relative to the Earth) at polar traversal. Similarly, downward facing links (which refers to links between a satellite and ground stations), or upward facing links (which refers to links between a satellite and higher layer constellations such as medium earth orbits (MEOs) or geosynchronous satellites (GEOs)) will also experience status and characteristics changes over time. The position, distance and quality of the link will vary as the satellite moves, and it will be subjected to predictable “almanac” based up/down events. This makes traffic engineering for a satellite network much more complicated than ground based networks. Especially when the engineering desired is relative to the Earth's surface.

Link state protocols carry metrics associated with a given link which are used to tune the routing that occurs. These metrics can be used as minimization criteria in a Dijkstra or other type of graph computation. An example of this is the open shortest path first (OSPF) or intermediate system-to-intermediate system (ISIS) link weight, where the shortest path is defined as the minimum sum of link weights. Attributes can also be used to exclude or include certain links. For example, the OSPF opaque attribute can carry link “colors,” which allow routes to be computed that include/exclude only links of a given color. Attributes of this nature are the primary inputs for traffic engineering computations, which is a well-known routing art used by various traffic engineering protocols on static networks.

Accordingly, there is a need for methods and devices for traffic engineering techniques for networks of infrastructure nodes which move relative to the Earth that are not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide methods and devices for techniques for aerial node link based traffic engineering. An aerial node is an infrastructure node (one which relays packets) which moves relative to the Earth.

An aspect of the disclosure provides for a method of setting an attribute of a link between an aerial network node and another node. The method comprises determining that a geographic condition of the link in relation to the aerial network node is satisfied. The method further comprises setting at least one attribute of the link to match at least one attribute associated with the geographic condition. In some embodiments the geographic condition of the aerial network node is one of a position of the aerial network node, a coverage area of the aerial network node, a geographic location of the link between the aerial network node and the another node, and a geographic location of at least a portion of the link between the aerial network node and the another node. In some embodiments the geographic condition of the aerial network node is satisfied by at least one of a predicted movement of the aerial network node as a function of time, a cartographic region on Earth, and a region defined by a mathematical function. In some embodiments the aerial network node is a satellite and the another node includes one of a ground station, and another satellite. In some embodiments the determining step is carried out by one of a ground station, and a satellite. In some embodiments the setting step is carried out by one of a ground station, and a satellite. In some embodiments the at least one attribute includes one of a downlink link attribute, an inter-satellite link (ISL) attribute, and a general operational attribute. In some embodiments the at least one attribute includes a link attribute including at least one of an intermediate system-to-intermediate system (ISIS) attribute, an open shortest path first (OSPF) attribute, a frequency attribute, a power attribute, a coding attribute, and a ground station address attribute. In some embodiments the geographic condition of the aerial network node is satisfied by at least one of a location of the aerial network node with respect to the Earth, or another set of infrastructure nodes at a higher or lower orbit; a location of the existing link with respect to the Earth, or another set of infrastructure nodes at a higher or lower orbit; or a location of at least a portion of the existing link with respect to the Earth, or another set of infrastructure nodes at a higher or lower orbit. In some embodiments setting at least one attribute of the link to match at least one attribute associated with the geographic condition includes creating a new link between the aerial network node and the another node having the at least one attribute. In some embodiments the link is and existing link, and setting at least one attribute of the link to match at least one attribute associated with the geographic condition includes modifying the existing link.

Another aspect of the disclosure provides for an aerial network node including at least one network interface, at least one processor, and a non-transient computer readable memory for storing instructions which when executed by the at least one processor configure the aerial network node to determine that a geographic condition of a link between the aerial network node and another node, in relation to the aerial network node is satisfied. The network node is further configured to set at least one attribute of the link to match at least one attribute associated with the geographic condition. In some embodiments the geographic condition of the aerial network node is one of a position of the aerial network node, a coverage area of the aerial network node, a geographic location of the link between the aerial network node and the another node, and a geographic location of at least a portion of the link between the aerial network node and the another node. In some embodiments the geographic condition of the aerial network node is satisfied by at least one of a predicted movement of the aerial network node as a function of time, a cartographic region on Earth, and a region defined by a mathematical function. In some embodiments the aerial network node is a satellite and the another node includes one of a ground station, and another satellite. In some embodiments the determining step is carried out by one of a ground station, and a satellite. In some embodiments the setting step is carried out by one of a ground station, and a satellite. In some embodiments the at least one attribute includes one of a downlink link attribute, an inter-satellite link (ISL) attribute, and a general operational attribute. In some embodiments the at least one attribute includes a link attribute including at least one of an intermediate system-to-intermediate system (ISIS) attribute, an open shortest path first (OSPF) attribute, a frequency attribute, a power attribute, a coding attribute, and a ground station address attribute. In some embodiments the geographic condition of the aerial network node is satisfied by at least one of a location of the aerial network node with respect to the Earth, or another set of infrastructure nodes at a higher or lower orbit; a location of the existing link with respect to the Earth, or another set of infrastructure nodes at a higher or lower orbit; or a location of at least a portion of the existing link with respect to the Earth, or another set of infrastructure nodes at a higher or lower orbit. In some embodiments setting at least one attribute of the link to match at least one attribute associated with the geographic condition includes creating a new link between the aerial network node and the another node having the at least one attribute. In some embodiments the link is and existing link, and setting at least one attribute of the link to match at least one attribute associated with the geographic condition includes modifying the existing link.

### BRIEF DESCRIPTION OF THE FIGURES

Further features and advantages of the present invention will become apparent from the following detailed description, taken in combination with the appended drawings, in which:

FIG. 1 depicts a method of setting an attribute of a link between an aerial network node and another node, according to embodiments of the present invention.

FIG. 2 depicts an example illustration of movement of a link between two nodes as a function of time, according to embodiments of the present invention.

FIG. 3 depicts an example region having a shaded sub-region that is subject to aerial network node links, according to embodiments of the present invention.

FIG. 4 is a block diagram of an electronic device that may be used for implementing devices and methods in accordance with representative embodiments of the present invention.

It will be noted that throughout the appended drawings, like features are identified by like reference numerals.

### DETAILED DESCRIPTION

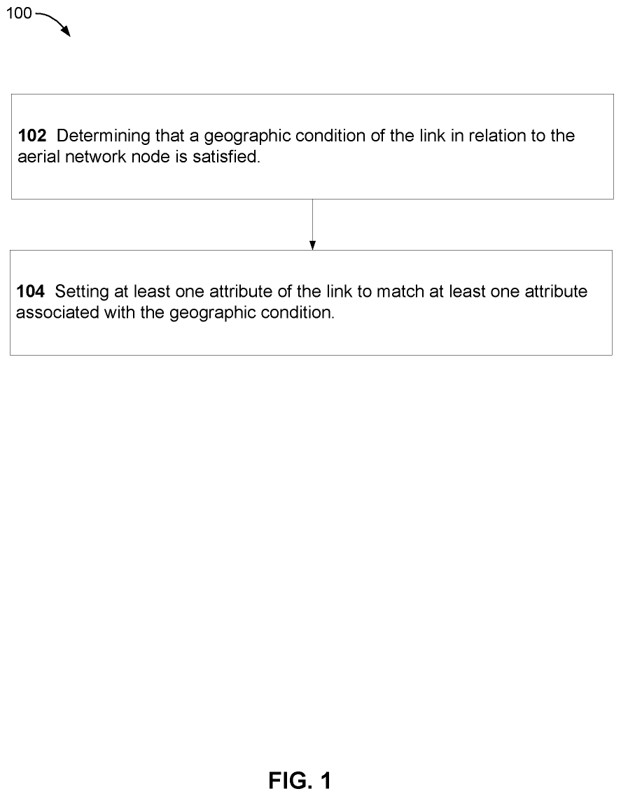

FIG. 1 depicts a method 100 of setting an attribute of a link between an aerial network node and another node. The method comprises, at step 102, determining that a geographic condition of the link in relation to the aerial network node is satisfied. The method further comprises, at step 104, setting at least one attribute of the link to match at least one attribute associated with the geographic condition. Traffic engineering may thus be defined relative to the surface of the Earth, and may automatically be adjusted based on the movement of an aerial network node.

In some embodiments the geographic condition of the aerial network node can include one of a position of the aerial network node, a coverage area of the aerial network node, a geographic location of the link between the aerial network node and the another node, and a geographic location of at least a portion of the link between the aerial network node and the another node. The geographic condition may therefore be satisfied when the aerial network node physically moves, when changes in its coverage area are detected, or when changes in the location of the link, or at least a portion of the link, are detected.

In some embodiments the geographic condition of the aerial network node is satisfied by at least one of a predicted movement of the aerial network node as a function of time, a cartographic region on Earth, and a region defined by a mathematical function. A predicted movement of the aerial network node may include an almanac based system in which it is straightforward to predict where the aerial network node may be at any given time. A cartographic region on Earth may include villages, towns, cities, states, provinces or even entire nations or continents. Using these principles, attributes may be set based on when an aerial network node enters or leaves a particular constraint region. Similarly, regions may be generated using mathematical functions. Regions created this way may include regular polygons, circles, ellipses, or the like.

In some embodiments the aerial network node is a satellite and the another node includes one of a ground station, and another satellite. Where both the aerial network node is a satellite and the another node is a satellite, it may be reasonably appreciated that the link between the two may be an inter-satellite link (ISL).

In some embodiments the determining step is carried out by one of a ground station, and a satellite. In some embodiments the setting step is carried out by one of a ground station, and a satellite. Different ground stations may possess different levels of authority. For example, a regional operator may possess only limited abilities to modify characteristics of the satellite, while a satellite operator may possess full, unrestricted capabilities.

In some embodiments the at least one attribute includes one of a downlink link attribute, an inter-satellite link (ISL) attribute, and a general operational attribute. Downlink link changes may be defined independent of aerial network node constellations and may be used to match regions where regulatory constraints exist.

Similarly, in some embodiments the at least one attribute includes a link attribute including at least one of an intermediate system-to-intermediate system (ISIS) attribute, an open shortest path first (OSPF) attribute, a frequency attribute, a power attribute, a coding attribute, and a ground station address attribute. Attributes may be computed based on a script which executes when it is determined that the geographic condition of the aerial network node has been satisfied.

In some embodiments the geographic condition of the aerial network node is satisfied by at least one of a location of the aerial network node with respect to the Earth, or another set of infrastructure nodes at a higher or lower orbit; a location of the existing link with respect to the Earth, or another set of infrastructure nodes a higher or lower orbit; or a location of at least a portion of the existing link with respect to the Earth, or another set of infrastructure nodes at a higher or lower orbit. Thus, in some embodiments, minor modifications to link-state protocols coupled with existing route computations may be used to provide for traffic engineering in space.

In some embodiments setting at least one attribute of the link to match at least one attribute associated with the geographic condition includes creating a new link between the aerial network node and the another node having the at least one attribute.

In some embodiments the link is an existing link, and setting at least one attribute of the link to match at least one attribute associated with the geographic condition includes modifying the existing link.

An aerial network node may be configured to determine that a geographic condition of a link, or at least a portion of a link, between the aerial network node and another node, in relation to the aerial network node is satisfied. The network node is further configured to set at least one attribute of the link to match at least one attribute associated with the geographic condition.

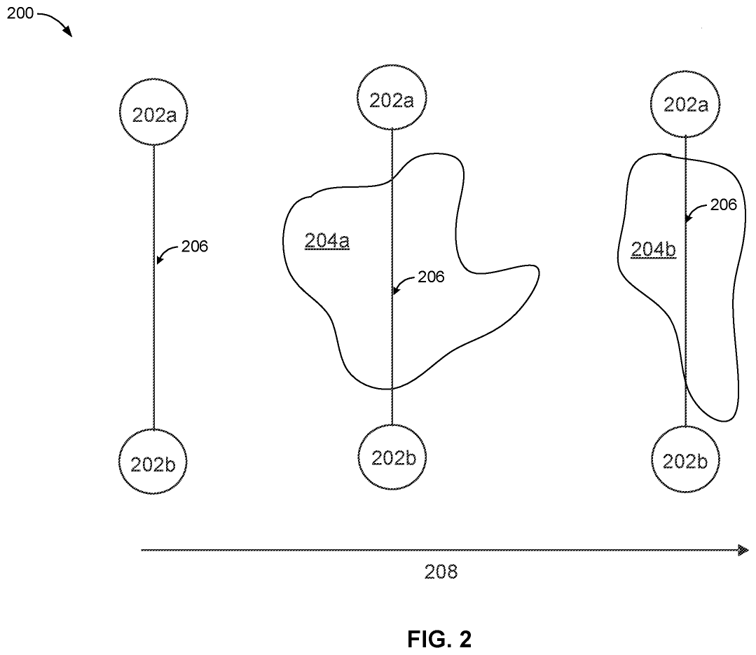

FIG. 2 depicts an example illustration 200 of movement of a link 206 between two aerial network nodes, 202a and 202b, as function of time. Arrow 208 defines the direction of movement of both the aerial network nodes 202a and 202b, and the link 206. As the link 206 passes over a first region 204a, the link attributes of the link 206 may change. Another change may occur in the link attributes of the link 206 as it passes over a second region 204b.

In FIG. 2, regions 204a and 204b may be called constraint regions on the surface of the earth, as they may be contained in a polygon, ellipse or circle mapped to the surface of the Earth. Each vertex of the polygon or focal point may be defined as the latitudinal and longitudinal coordinates of that point or, similarly, its X-Y-Z coordinates. When the link 206 between aerial network nodes 202a and 202b intersects a particular constraint region (i.e., passes over it), the link attributes associated with the constraint region are inherited by the link 206 for the purposes of routing computations by any node which sees the link 206 and includes it in its computations.

Moreover, when an aerial network node enters a constraint region (i.e., passes over it), the attributes associated with that constraint region may be inherited by the aerial network node. In particular, the attributes may be for downlink control, including elements such as frequency, power, coding or ground station addresses. Thus providing a form of “satellite slicing”.

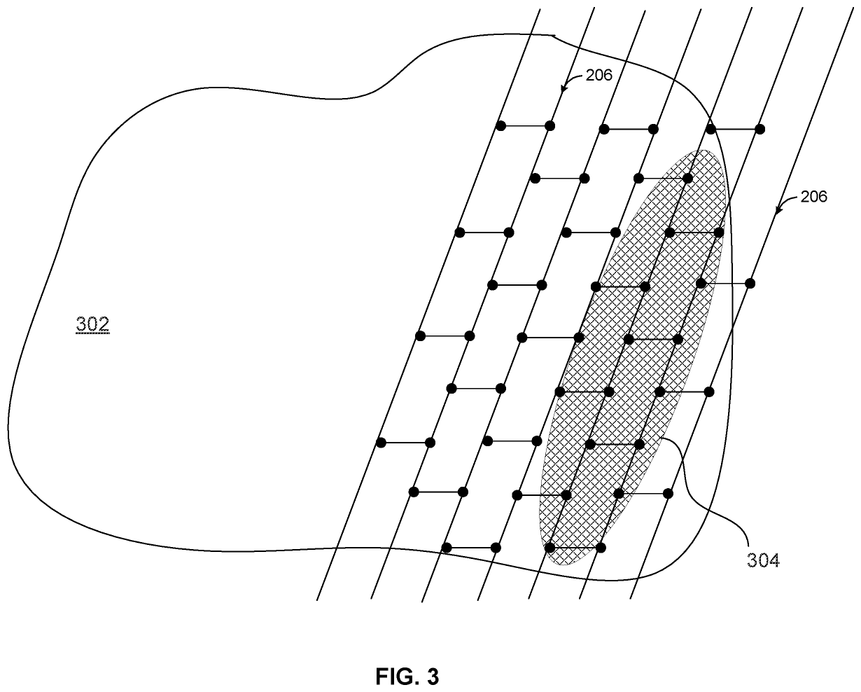

Referring now to FIG. 3, some possible advantages of the invention will be discussed. FIG. 3 depicts a region 302 having a shaded sub-region 304. As an example scenario, there may be a corridor between two major cities that carries important traffic which will follow explicit source routes pre-computed by ground stations. Therefore, it would be undesirable to have best effort traffic use those routes. Instead, links 206 along the corridor between the cities could be used to carry higher metrics for best effort traffic. In order to accomplish this, the subregion 304 may be defined along the corridor to force the link metrics to be different when a link 206 crosses the subregion 304 but to return to normal everywhere else. In this manner, traffic routed using Shortest Path First (SPF) algorithms will prefer not to go through this corridor (subregion 304) if at all possible. Purely as an example, in FIG. 3, the aerial network nodes are represented by the filled black circles.

The subregions and actions within particular regions may be defined with a scripting language to increase the granularity of options within the regions. A region may be defined with a set of bounding points. The region may be associated with actions where actions can have conditions. For example:

In Region <pt1, pt2, p3, p4>
Between 10:00Zulu and 15:00Zulu
When Sat.direction>XXX degrees
   Set Sat.link[WEST].metric=100

In this regard, a region may also be used to control downlink frequencies and properties so that proper regulations for frequency, power or coding may be used in various different regions. A scripting language may include functions that return information including a global time, hardware health indicators, or link statuses. Scripting may also be utilized to include further downlink attributes, such as encryption options.

The scripting language may be a union of a set of uploads from a plurality of sources but where rules as to which reference frames may be defined by which sources is enforced to prevent unauthorized reference frame control

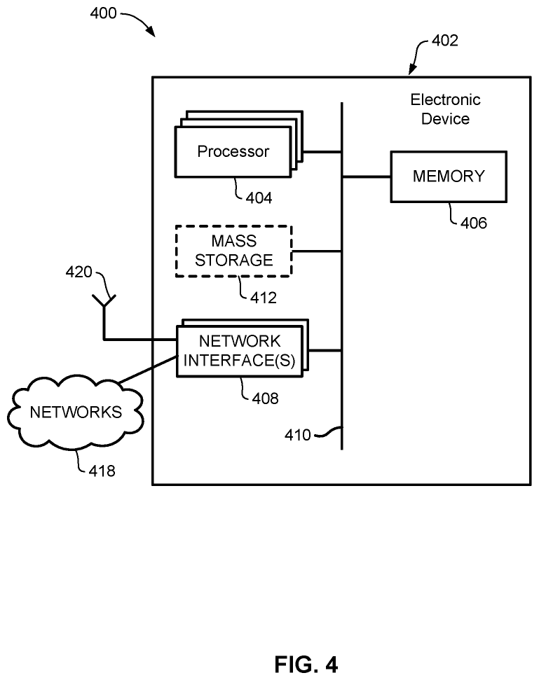

FIG. 4 is a block diagram of an electronic device (ED) 402 illustrated within a computing and communications environment 400 that may be used for implementing the devices and methods disclosed herein. The person having skill in the art will reasonably appreciate that the aerial network node may be an ED 402, and that the methods disclosed herein may be executed on an ED 402. In some embodiments, the ED 402 may be an element of communications network infrastructure, such as a base station, for example a NodeB, an enhanced Node B (eNodeB), a next generation NodeB (sometimes referred to as a gNodeB or gNB), a home subscriber server (HSS), a gateway (GW) such as a packet gateway (PGW) or a serving gateway (SGW) or various other nodes or functions within an evolved packet core (EPC) network. In other embodiments, the ED may be a device that connects to network infrastructure over a radio interface, such as a mobile phone, smart phone or other such device that may be classified as a User Equipment (UE). In some embodiments, ED 402 may be a Machine Type Communications (MTC) device (also referred to as a machine-to-machine (m2m) device), or another such device that may be categorized as a UE despite not providing a direct service to a user. In some references, an ED may also be referred to as a mobile device, a term intended to reflect devices that connect to mobile network, regardless of whether the device itself is designed for, or capable of, mobility. In some embodiments, ED 402 may be an aerial network node such as a satellite. Specific devices may utilize all of the components shown or only a subset of the components, and levels of integration may vary from device to device. Furthermore, an ED 402 may contain multiple instances of a component, such as multiple processors, memories, transmitters, receivers, etc. The ED 402 typically includes a processor 404, such as a Central Processing Unit (CPU), and may further include specialized processors, a memory 406, a network interface 408 and a bus 410 to connect the components of ED 402. ED 402 may optionally also include components such as a mass storage device 412 (shown in dashed lines).

The memory 406 may comprise any type of non-transitory system memory, readable by the processor 404, such as static random access memory (SRAM), dynamic random access memory (DRAM), synchronous DRAM (SDRAM), read-only memory (ROM), or a combination thereof. In an embodiment, the memory 106 may include more than one type of memory, such as ROM for use at boot-up, and DRAM for program and data storage for use while executing programs. The bus 410 may be one or more of any type of several bus architectures including a memory bus or memory controller, a peripheral bus, or a video bus.

The ED 402 may also include one or more network interfaces 408, which may include at least one of a wired network interface and a wireless network interface. As illustrated in FIG. 4, network interface 408 may include a wired network interface to connect to a network 418, and also may include a radio access network interface 420 for connecting to other devices over a radio link. When ED 402 is network infrastructure, the radio access network interface 420 may be omitted for nodes or functions acting as elements of the Core Network (CN) other than those at the radio edge (e.g. an eNB). When ED 402 is infrastructure at the radio edge of a network, both wired and wireless network interfaces may be included. When ED 402 is a wirelessly connected device, such as a User Equipment, radio access network interface 420 may be present and it may be supplemented by other wireless interfaces such as WiFi network interfaces. The network interfaces 408 allow the ED 402 to communicate with remote entities such as those connected to network 418.

The mass storage 412 may comprise any type of non-transitory storage device configured to store data, programs, and other information and to make the data, programs, and other information accessible via the bus 410. The mass storage 412 may comprise, for example, one or more of a solid state drive, hard disk drive, a magnetic disk drive, or an optical disk drive. In some embodiments, mass storage 412 may be remote to the ED 402 and accessible through use of a network interface such as interface 408. In the illustrated embodiment, mass storage 412 is distinct from memory 406 where it is included, and may generally perform storage tasks compatible with higher latency, but may generally provide lesser or no volatility. In some embodiments, mass storage 412 may be integrated with a heterogeneous memory 406.

In some embodiments, ED 402 may be a standalone device, while in other embodiments ED 402 may be resident within a data center. A data center, as will be understood in the art, is a collection of computing resources (typically in the form of servers) that can be used as a collective computing and storage resource. Within a data center, a plurality of servers can be connected together to provide a computing resource pool upon which virtualized entities can be instantiated. Data centers can be interconnected with each other to form networks consisting of pools computing and storage resources connected to each by connectivity resources. The connectivity resources may take the form of physical connections such as Ethernet or optical communications links, and in some instances may include wireless communication channels as well. If two different data centers are connected by a plurality of different communication channels, the links can be combined together using any of a number of techniques including the formation of link aggregation groups (LAGs). It should be understood that any or all of the computing, storage and connectivity resources (along with other resources within the network) can be divided between different sub-networks, in some cases in the form of a resource slice. If the resources across a number of connected data centers or other collection of nodes are sliced, different network slices can be created.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method of setting an attribute of a link between a first aerial network node and a second aerial network node of a network, the method comprising:
determining, by one of the first aerial network node and the second aerial network node, that a geographic location of at least a portion of the link in relation to the first aerial network node intersects a constraint region on a surface of the Earth;
setting, by the one of the first aerial network node and the second aerial network node, at least one link attribute of a plurality of link attributes of the link to match at least one attribute associated with the constraint region.

2. (canceled)

3. The method of claim 1, wherein the constraint region is one of:
a cartographic region on the surface of the Earth; and
a region defined by a mathematical function.

4. The method of claim 1, wherein the first aerial network node is a satellite and the second aerial network node is:
another satellite and wherein the link is an inter-satellite link (ISL).

5. (canceled)

6. (canceled)

7. The method of claim 1, wherein the at least one link attribute includes one of:
an inter-satellite link (ISL) attribute; and
a general operational attribute.

8. The method of claim 1, wherein the at least one link attribute includes at least one of:
an intermediate system-to-intermediate system (ISIS) attribute;
an open shortest path first (OSPF) attribute;
a frequency attribute;
a power attribute; and
a coding attribute;

9. (canceled)

10. (canceled)

11. (canceled)

12. An aerial network node comprising:
at least one network interface;
at least one processor;
a non-transitory computer readable memory for storing instructions which when executed by the at least one processor configure the aerial network node to:
determine that a geographic location of at least a portion of a link between the aerial network node and another aerial network node, in relation to the aerial network node intersects a constraint region on a surface of the Earth;
set at least one link attribute of a plurality of link attributes of the link to match at least one attribute associated with the constraint region.

13. (canceled)

14. The aerial network node of claim 12, wherein the the constraint region is one of:
a cartographic region on the surface of the Earth; and
a region defined by a mathematical function.

15. The aerial network node of claim 12, wherein the aerial network node is a satellite and the another aerial network node is another satellite, and wherein the link is an inter-satellite link.

16. The aerial network node of claim 12, wherein the at least one attribute includes one of:
an inter-satellite link (ISL) attribute; and
a general operational attribute.

17. The aerial network node of claim 12, wherein the at least one attribute includes at least one of:
an intermediate system-to-intermediate system (ISIS) attribute;
an open shortest path first (OSPF) attribute;
a frequency attribute;
a power attribute; and
a coding attribute

18. (canceled)

19. (canceled)

20. (canceled)

21. The method of claim 1 further comprising sending, by the one of the first aerial network node and the second aerial network node, the plurality of link attributes of the link, including the at least one link attribute that matches the at least one attribute of the constraint region, to at least one other aerial network node of the network for performing routing computations.

22. The method of claim 1 further comprising:
performing, one of the first aerial network node and the second aerial network node, routing computations using at least the plurality of link attributes of the link, including the at least one link attribute that matches the at least one attribute of the constraint region.

23. The method of claim 1 wherein the constraint region is a one of a polygon, an ellipse or a circle mapped to the surface of the Earth.

24. The aerial network node of claim 12 wherein the instructions further configure aerial network node to send the plurality of link attributes including the at least one link attribute that matches the at least one attribute of the constraint region, to at least one other aerial network node for performing routing computations.

25. The aerial network node of claim 12 wherein the instructions further configure aerial network node to perform computations using at least the plurality of link attributes of the link, including the at least one link attribute that matches the at least one attribute of the constraint region.

26. The aerial network node of claim 12 wherein the constraint region is a one of a polygon, an ellipse or a circle mapped to the surface of the Earth
